(19) United States
(12) Patent Application Publication
(10) Pub. No.: US 2014/0181117 A1
(43) Pub. Date: Jun. 26, 2014

(54) PERSON SEARCH METHOD AND APPARATUS

(71) Applicant: TENCENT TECHNOLOGY (SHENZHEN) COMPANY LIMITED, Shenzhen (CN)

(72) Inventors: Yifeng SHI, Shenzhen (CN); Shushen PAN, Shenzhen (CN); Jianguo HE, Shenzhen (CN); Liao LIN, Shenzhen (CN); Xu WEN, Shenzhen (CN); Weibo WANG, Shenzhen (CN); Liang WANG, Shenzhen (CN)

(73) Assignee: TENCENT TECHNOLOGY (SHENZHEN) COMPANY LIMITED, Shenzhen (CN)

(21) Appl. No.: 14/179,190

(22) Filed: Feb. 12, 2014

Related U.S. Application Data
(63) Continuation of application No. PCT/CN2012/077898, filed on Jun. 29, 2012.

(30) Foreign Application Priority Data
Aug. 19, 2011 (CN) 201110239162.7

(51) Int. Cl. G06F 17/30

(52) U.S. Cl. CPC G06F 17/30867
USPC 707/741; 707/769; 707/775; 707/748

(57) ABSTRACT

According to an example, a search request is received, and the search request comprises a search keyword and information of a current user; interpersonal relationship chain data of the current user are obtained according to the information of the current user; person information corresponding to the interpersonal relationship chain data of the current user is searched for a person matching the search keyword; and the person matching the search keyword is taken as a search result.

### CROSS-REFERENCES TO RELATED APPLICATIONS

This application is a continuation of International Application No. PCT/CN2012/077898, filed on Jun. 29, 2012, which claims priority to Chinese Patent Application No. 201110239162.7, filed on Aug. 19, 2011, the entire contents of all of which are incorporated herein by reference in their entirety for all purposes.

### TECHNICAL FIELD

The present invention relates to Internet information search technologies, and more particularly, to a person search method and apparatus.

### BACKGROUND

With the developments of Internet information communication technologies, people increasingly rely on Internet communications when communicating with others. In real life, people have their own social relationships, and the social relationships may be gradually mapped to a network relationship chain via various Internet applications, e.g. E-mails, online communities, groups, classmate alumni and etc. When using these network applications, people may make more new friends and the network relationship chain grows increasingly. The network relationship chain including rich personal relationship information has great value. They may be used for consolidating old relationships, such as finding a friend once knew, or may be used for developing new social relationships based on contacts of a first-level, second-level and n^{th}-level, n is larger than 2.

As long as people become increasingly dependent on the Internet, there is demand for finding more friends to expand the social relationships via Internet technologies.

Currently, a person search technology dedicated to search for persons occurs on the Internet. Users may search out persons with certain features and add the persons as buddies by using the person search technology.

However, the current person search system just introduces some simple interpersonal factors, and it is not convenient for the user to find the target objects having high correlation with the interpersonal relationship of the user. Further, in order to select the target objects, the user often needs to click to view information of each person, which increases the number of human-computer interactions between a user side and an opposite side on the Internet. When each human-computer interaction is performed, operation request information is sent, and a calculating procedure is triggered to generate response result information, thereby occupying many machine-side resources e.g. client resources, server resources, network bandwidth resources, etc.

### SUMMARY

Examples of the present invention provide a person search method and apparatus, so as to improve interpersonal correlation between search results and a user, and to reduce resource occupancy rate.

The examples provide the following technical solutions.

A people search method includes:

receiving a search request, the search request comprising a search keyword and information of a current user;

obtaining interpersonal relationship chain data of the current user according to the information of the current user;

searching person information corresponding to the interpersonal relationship chain data of the current user for a person matching the search keyword; and

taking the person matching the search keyword as a search result.

A people search apparatus includes: a memory and a processor for executing instructions stored in the memory, the instructions comprise:

a search request instruction, adapted to receive a search request, the search request comprising a search keyword and information of a current user;

a data obtaining instruction, adapted to obtain interpersonal relationship chain data of the current user according to the information of the current user;

a matching instruction, adapted to search person information corresponding to the interpersonal relationship chain data of the current user for a person matching the search keyword; and

a result instruction, to take the person matching the search keyword as a search result.

According to the examples of the present disclosure, the interpersonal relationship chain data of the current user are provided, matching operations for the search keyword are performed based on the interpersonal relationship chain data. In this way, network community relationships are used in the procedure of person search, so that the persons in the search result belong to the interpersonal relationship chain of the current user, the correlation between the user and the search result is improved, and it is convenient for the user to find the target objects. Therefore, individuation search requirements of the user are satisfied, the number of human-computer interactions performed by the user is reduced, and resource occupancy rate is reduced.

### BRIEF DESCRIPTION OF THE DRAWINGS

FIG. 1 is a schematic flowchart illustrating a person search method according to various examples of the present invention.

FIG. 2 is a schematic flowchart illustrating a person search method according to various examples of the present invention.

FIG. 3 is a schematic diagram illustrating a person search apparatus according to various examples of the present invention.

FIG. 4 is a schematic diagram illustrating a person search apparatus according to various examples of the present invention.

FIG. 5 is a schematic diagram illustrating a person search apparatus according to various examples of the present invention.

### DETAILED DESCRIPTION

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various examples given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed as A only, B only, C only, or any combination of two or more items A, B and C. It should be understood that one or more steps within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

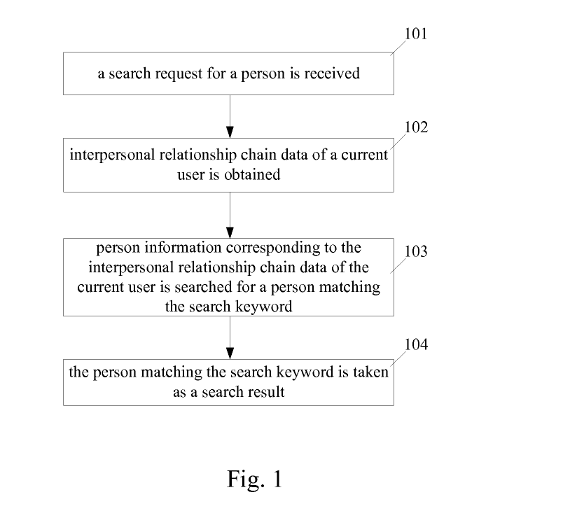

The description will be made as to the embodiments of the present invention in conjunction with the accompanying drawings in FIGS. 1-5. It should be understood that specific embodiments described herein are merely intended to explain the present invention, but not intended to limit the present invention. In accordance with the purposes of this invention, as embodied and broadly described herein, this invention, in one aspect, relates to person search method and apparatus.

Examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

FIG. 1 is a schematic flowchart illustrating a person search method according to various examples of the present invention.

At 101, a search request for a person is received, and the search request includes a search keyword and information of a current user.

According to an example, the information of the current user may be an identifier (ID) of the current user.

At 102, interpersonal relationship chain data of the current user is obtained according to the information of the current user.

According to an example, the method may be applied to a certain network application platform. The current user may be a single user, e.g. a member logging on a network application platform. The current user may be a group user, such as an Instant Message (IM) chat group, e.g. a QQ group, or a micro-blog group and so on.

In addition, the current user may be a user currently logging on the system, or may be a current designated user. When the current user is the user currently logging on the system, that is, a user sending the search request is the user currently logging on the system, since the ID of the current user may be obtained directly from the search request, the user sending the search request does not need input the ID of the current user before sending the search request. When the current user is a current designated user, that is, the user sending the search request designates a user as the current user, the user sending the search request needs to input the ID of the current user before sending the search request.

By using the method, persons interpersonally related to the current user may be searched out.

At 103, person information corresponding to the interpersonal relationship chain data of the current user is searched for a person matching the search keyword.

At 104, the person matching the search keyword is taken as a search result.

According to an example, the interpersonal relationship chain data of a certain user refer to interpersonal relationship data directly or indirectly generated for the user in at least one network community, and mainly include direct interpersonal relationship data and indirect interpersonal relationship data.

The direct interpersonal relationship data refer to person data directly related to the user, such as, identities of buddies in a community system (e.g. buddy IDs), identities of classmates in a classmate alumni system (e.g. names of the classmates), identities of contacts in an e-mail system (e.g. codes or e-mail addresses of the contacts), identities of members in a group (e.g. IDs of the members) and etc. The above interpersonal relationship data are most related to the user and are called first-level interpersonal relationship chain data. The first-level is the most intimate level in the example.

The indirect interpersonal relationship data refer to person data which are indirectly related to the user and generated based on the first-level interpersonal relationship chain data. The indirect interpersonal relationship data include second-level interpersonal relationship chain data or n^{th}-level interpersonal relationship chain data, n is an integer larger than 2. The second-level interpersonal relationship chain data include: second-level relationship chain data of a buddy relationship chain in the network community, e.g. the buddies of the buddies in the community system; second-level relationship chain data of an e-mail relationship chain, e.g. the contacts of the contacts in the e-mail system; second-level relation chain data of a classmate alumni relationship chain, e.g. classmates of the classmates, and etc. The n^{th}-level interpersonal relationship chain data, e.g. third-level interpersonal relationship chain data include buddies of the buddies of the buddies in the community system; classmates of the classmates of the classmates in the classmate alumni system.

In addition, the interpersonal chain relationship data of the current user also include weak community relationship data, e.g. person data of a person having the same hometown, the same school, the same age range, the same hobby, and etc.

There are two modes for obtaining the interpersonal relationship chain data of the current user at 102.

In one mode, the interpersonal relationship chain data of the current user may be obtained from a client terminal of the current user. In this mode, a network application system includes interpersonal relationship chain data of single users and group users. When the user logs on the network application system, the network application system sends interpersonal relationship chain data corresponding to an ID of the single user to the client terminal to be stored. When the user logs on a certain group, the network application system sends interpersonal relationship chain data corresponding to a group ID to the client terminal to be stored. After the user submits a search instruction, the client terminal submits the interpersonal relationship chain data corresponding to the ID of the single user or the interpersonal relationship chain data corresponding to the group ID to a search system to perform subsequent operations.

In the other mode, an interpersonal relationship chain database of single users or group users is established in advance. After the user submits the search instruction, the interpersonal relationship chain database is searched according to an ID of the current user or an ID of the current group, and the interpersonal relationship chain data corresponding to the ID of the current user or the ID of the current group are obtained.

Currently, various network applications may provide data basis for the examples of the present disclosure. For example, the network community system may provide community buddy relationship chain data, e.g. QQ buddy chain data, friend community relationship chain data and post bar relationship data; the e-mail system may provide e-mail relationship chain data; the group system may provide group relationship chain data, e.g. QQ group data and micro-blog group etc.; the classmate alumni system may provide classmate relationship chain data.

In the procedure of establishing the interpersonal relationship chain database, the interpersonal relationship chain data are imported from the network application systems and stored in the interpersonal relationship chain database. For the network application system concerning the single users, e.g. the community system or the e-mail system, the stored interpersonal relationship chain data include user IDs and interpersonal relationship chain data corresponding to each of the user IDs, such as the buddies of the user (first-level relationship chain), buddies of the buddies (second-level relationship chain). For the network application system concerning the group users, e.g. the QQ group system or the micro-blog group system, the stored interpersonal relationship chain data include group IDs and interpersonal relationship chain data corresponding to each of the group IDs, such as all members in the group (first-level relationship chain), members in another group to which the member of the group belongs (second-level relationship chain). In addition, the weak community relationship data may be imported from other network application systems and stored in the interpersonal relationship chain database.

According to an example, when the interpersonal relationship chain data imported from another network application system only include first-lever relationship chain data, second-level relationship chain data or n^{th}-level relationship chain data may be obtained from the corresponding network application system, so as to obtain the interpersonal relationship chain data of different intimate levels. Modes for obtaining the interpersonal relationship chain data of different intimate levels may refer to existing technologies and will not be described herein.

In addition, according to an example, when the interpersonal relationship chain database of the user is established, weighted calculation may be performed for person data of the interpersonal relationship chain data, and the interpersonal relationship chain data may be sorted according to a weighted result, and the sorted interpersonal relationship chain data are stored in the database. Weight factors of the weighted calculation include at least one of:

an intimate level of a person in an interpersonal relationship of the user;

the number of mutual buddies of a person and the user; and

whether a person has a weak community relationship with the user.

The value of the weight factor may be configured according practical conditions. Generally, the weight factor of the first-level interpersonal relationship chain is larger than the weight factor of the second-level interpersonal relationship chain and the weight factor of the second-level interpersonal relationship chain is larger than the weight factor of the weak community relationship. When the person has more mutual friends with the user, the value of the weight factor is larger.

At 102, if the interpersonal relationship chain data currently obtained only include the first-lever interpersonal relationship chain data or only include the first-level and the second-level interpersonal relationship chain data, expansion processing may be performed for the interpersonal relationship chain data, so as to obtain the interpersonal relationship chain data of different intimate levels. The interpersonal relationship chain data of different intimate levels are to be used at 103.

The person information at 103 may be person information in a person database of a network application system, or may be person index information obtained based on a person database. There are two modes for implementing the processing at 103.

The first mode includes processing at 311 and 312.

At 311, all persons matching the search keyword are searched out from the person database. The person database includes all information of all persons, such as, ID numbers, names, genders, schools, hobbies, signature information and etc. so that all persons matching the search keyword may be searched out from the person database.

At 312, persons belonging to the interpersonal relationship chain data of current user at 102 are selected from the matched persons obtained at 311, that is, intersection of the persons obtained at 311 and the person in the interpersonal relationship chain data obtained at 102 is obtained, and the intersection is the search result.

In the second mode, an interpersonal relationship chain database for users is established in advance. Person index information of the interpersonal relationship chain data of each user in configured in the interpersonal relationship chain database. The person index information indexes the person information of the interpersonal relationship chain data of the user by using a single user ID as a key or indexes the person information of the interpersonal relationship chain data of the group by using a group ID as a key. The person information includes, such as, ID numbers, names, genders, schools, hobbies, signature information and etc. The second mode includes processing at 321 and 322.

At 321, person index information of the interpersonal relationship chain data of the current single user or group user is searched out according to an identifier of the current single user or the group user.

At 322, the person matching the search keyword is searched out from the person index information obtained at 321, and the person is taken as the search result.

After the processing at 103, the person matching with the search keyword is obtained, and the person may be in the first-level interpersonal relationship chain data, in the second-level interpersonal relationship chain data or in the weak relationship chain data.

At 104, weighted calculation may be performed for the persons obtained at 103, and the persons may be sorted according to a weighted result, and the sorted persons are taken as the search result. The search result may be returned to the user sending the search request, and may be display on a browser of the initiator or may be presented for the user sending the search request in other modes. The weighted factors of the weighted calculation include at least one of:

an intimate level of a person in an interpersonal relationship of the user;

the number of mutual buddies of a person and the user; and

whether a person has a weak community relationship with the user.

The value of the weighted factor may be configured according practical conditions. Generally, the weight factor of the first-level interpersonal relationship chain is larger than the weight factor of the second-level interpersonal relationship chain and the weight factor of the second-level interpersonal relationship chain is larger than the weight factor of the weak community relationship. When the person has more mutual friends with the user, the value of the weight factor is larger.

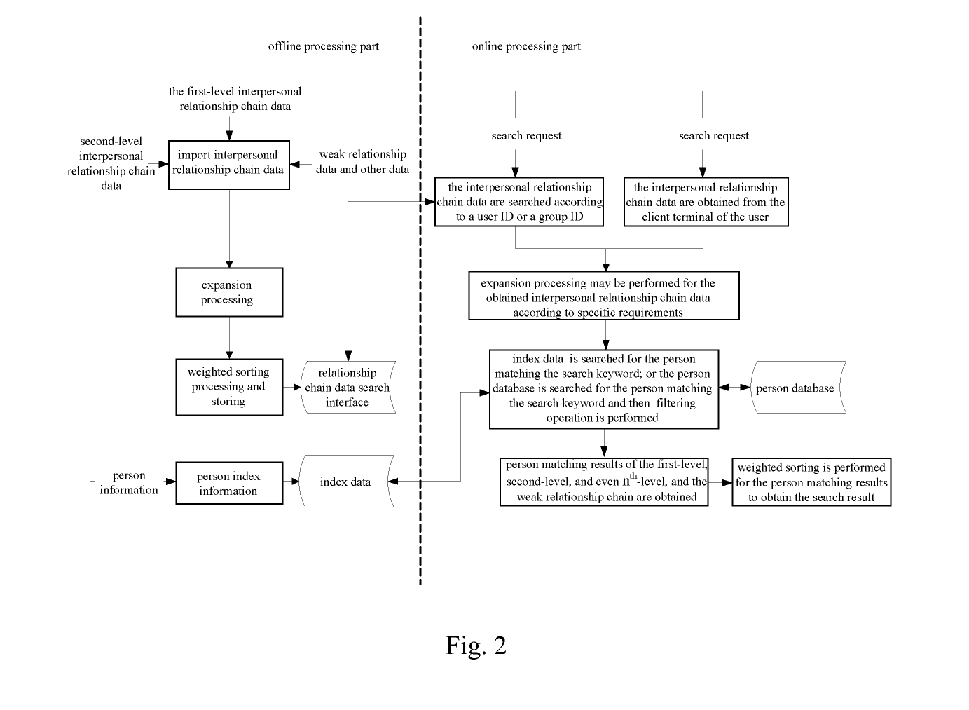

FIG. 2 is a schematic flowchart illustrating a person search method according to various examples of the present invention. As shown in FIG. 2, the left side of the dotted line indicates an offline processing part, and the right side of the dotted line indicates an online processing part.

In the offline processing part, it is needed to import the interpersonal relationship chain data of the first-level, second-level, and even n^{th}-level, the weak relationship data and other data. The expansion processing and the weighted sorting processing are performed for the imported interpersonal relationship chain data, then the processed data are stored in the interpersonal relationship chain database, and a relationship chain data search interface is provided, so that the online processing part may perform search operations. In addition, the person information may be input to establish the person index information for the interpersonal relationship chain data of each user, so that the online processing part may perform the search operations.

In the online processing part, the search request including the search keyword and the information of the current user is received, the interpersonal relationship chain data of the current user is searched by using the relationship chain search interface, or the interpersonal relationship chain data of the user may be directly obtained from the client terminal of the user. The expansion processing may be then performed for the obtained interpersonal relationship chain data of the user according to specific requirements. The index data established offline is searched according to the ID of the current user for the person index information of the interpersonal relationship chain data of the current user, and then the person index information is searched for the person matching the search keyword. Or, the person database is searched for the person matching the search keyword, and then the persons in the interpersonal relationship chain data of the current user is selected from the matched persons, this mode is also called filtering operation. Finally, person matching results of the first-level, second-level, and even n^{th}-level, and the weak relationship chain are obtained, and weighted sorting is performed for the person matching results to obtain the search result.

Therefore, by using the method provided by the examples of the present disclosure, the interpersonal relationship chain data are introduced, and the second-level or n^{th}-level of interpersonal relationship chain may be obtained according to the interpersonal relationship chain, social relationship factors, e.g. user match degrees may be calculated according to the interpersonal relationship chain, so that person search based on the relationship chain is implemented, and search requirements based on the community characteristic of the user is satisfied.

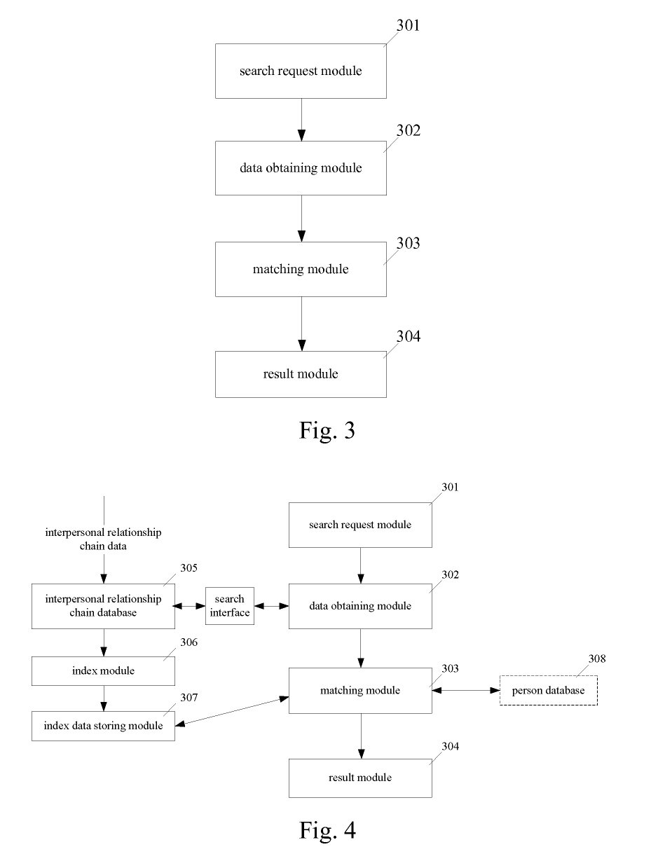

FIG. 3 is a schematic diagram illustrating a person search apparatus according to various examples of the present invention. As shown in FIG. 3, the apparatus includes a search request module 301, a data obtaining module 302, a matching module 303, and a result module 304.

The search request module 301 is to receive a search request for a person, and the search request includes a search keyword and information of a current user.

The data obtaining module 302 is to obtain interpersonal relationship chain data of the current user.

The matching module 303 is to search person information corresponding to the interpersonal relationship chain data of the current user for a person matching the search keyword.

The result module 304 is to take the person matching the search keyword as a search result.

FIG. 4 is a schematic diagram illustrating an apparatus of person search according to various examples of the present invention. As shown in FIG. 4, the apparatus further includes an interpersonal relationship chain database 305 to store the interpersonal relationship chain data of users. The data obtaining module 302 is further to obtain the interpersonal relationship chain data from the interpersonal relationship chain database 305 via a search interface. According to another example, the data obtaining module 302 is to obtain the interpersonal relationship chain data from a client terminal of the current user.

In the example shown in FIG. 4, the matching module 303 may match the search keyword in two modes.

In one mode, the matching module 303 is to search a person database 308 for all persons matching the search keyword, and then select the persons belonging to the interpersonal relationship chain of the current user obtained by the data obtaining module 302 from the persons matching the search keyword.

In the other mode, the apparatus further includes an index module 306 and an index data storing module 307. The index module 306 is to configure person index information of the interpersonal relationship chain data of each user in the interpersonal relationship chain database, and store the person index information in the index data storing module 307. In this mode, the matching module 303 includes a first searching unit and a second searching unit. The first searching unit is to search the index data storing module 307 for the person index information of the interpersonal relationship chain data of the current user according to an ID of the current user. The second searching unit is to search the person index information searched out by the first searching unit for the person matching the search keyword.

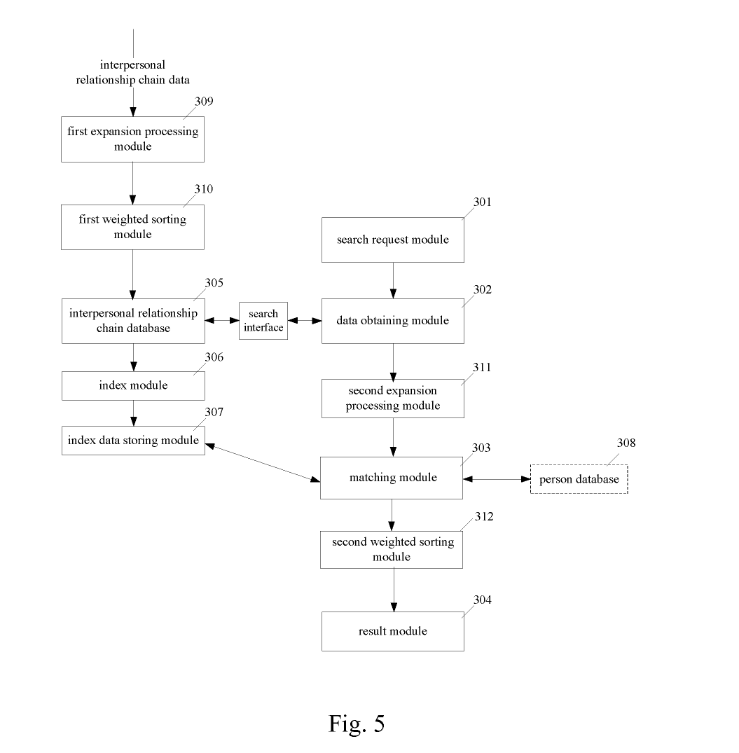

FIG. 5 is a schematic diagram illustrating a person search apparatus according to various examples of the present invention. As shown in FIG. 5, the apparatus further includes a first expansion processing module 309 to perform expansion processing for the interpersonal relationship chain data input to the interpersonal relationship chain database 305, obtain interpersonal relationship chain data of different intimate levels, and store the processed interpersonal relationship chain data to the interpersonal relationship chain database 305.

According to an example, if it is needed to perform weighted calculation, the apparatus may further includes a first weighted sorting module 310. The first weighted sorting module 310 is to perform the weighted calculation for the person data which are in the interpersonal relationship chain data of the user and are input into the interpersonal relationship chain database, sort the interpersonal relationship chain data according to a weighted result, and store the sorted interpersonal relationship chain data in the interpersonal relationship chain database 305.

The apparatus may further includes a second expansion processing module 311 located between the data obtaining module 302 and the matching module 303. The second expansion processing module is to perform expansion processing for the interpersonal relationship chain data obtained by the data obtaining module 302, obtain interpersonal relationship chain data of different intimate levels, and input the processed interpersonal relationship chain data to the matching module 303.

The apparatus may further include a second weighted sorting module 312 located between the matching module 303 and the result module 304. The second weighted sorting module 312 is to perform weighted calculation for the matched person data, sort the interpersonal relationship chain data according to a weighted result, and input the sorted interpersonal relationship chain data in the matching module 304.

According to various examples, the apparatus may include at least one of the first expansion processing module 309, the first weighted sorting module 310, the second expansion processing module 311 and the second weighted sorting module 312.

Examples of the present invention also provide a storage medium. The storage medium stores computer programs used to implement any example of the above methods.

The methods, modules and devices described herein may be implemented by hardware, machine-readable instructions or a combination of hardware and machine-readable instructions. Machine-readable instructions used in the examples disclosed herein may be stored in storage medium readable by multiple processors, such as hard drive, CD-ROM, DVD, compact disk, floppy disk, magnetic tape drive, RAM, ROM or other proper storage device. Or, at least part of the machine-readable instructions may be substituted by specific-purpose hardware, such as custom integrated circuits, gate array, FPGA, PLD and specific-purpose computers and so on.

A machine-readable storage medium is also provided, which is to store instructions to cause a machine to execute a method as described herein. Specifically, a system or apparatus having a storage medium that stores machine-readable program codes for implementing functions of any of the above examples and that may make the system or the apparatus (or CPU or MPU) read and execute the program codes stored in the storage medium.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

It should be noted that, alternatively to the program codes being executed by a computer, at least part of the operations performed by the program codes may be implemented by an operation system running in a computer following instructions based on the program codes to realize a technical scheme of any of the above examples.

In addition, the program codes implemented from a storage medium are written in a storage in an extension board inserted in the computer or in a storage in an extension unit connected to the computer. In this example, a CPU in the extension board or the extension unit executes at least part of the operations according to the instructions based on the program codes to realize a technical scheme of any of the above examples.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

1. A person search method, comprising:
receiving a search request, the search request comprising a search keyword and information of a current user;
obtaining interpersonal relationship chain data of the current user according to the information of the current user;
searching person information corresponding to the interpersonal relationship chain data of the current user for a person matching the search keyword; and
taking the person matching the search keyword as a search result.

2. The method of claim 1, wherein obtaining the interpersonal relationship chain data of the current user comprises:
obtaining the interpersonal relationship chain data of the current user from a client terminal of the current user.

3. The method of claim 1, further comprises: configuring an interpersonal relationship chain database for users in advance;
wherein obtaining the interpersonal relationship chain data of the current user comprises:
searching the interpersonal relationship chain database according to an identifier of the current user; and
obtaining the interpersonal relationship chain data of the current user.

4. The method of claim 3, when configuring the interpersonal relationship chain database for the current user, further comprising:
performing expansion processing for interpersonal relationship chain data input to the interpersonal relationship chain database;
obtaining interpersonal relationship chain data of different intimate levels;
storing the interpersonal relationship chain data of the different intimate levels in the interpersonal relationship chain database.

5. The method of claim 3, when configuring the interpersonal relationship chain database for the current user, further comprising:
performing weighted calculation for person data of interpersonal relationship chain data input to the interpersonal relationship chain database;
sorting the interpersonal relationship chain data according to a weighted result; and
storing the interpersonal relationship chain data sorted in the interpersonal relationship chain database.

6. The method of claim 1, after obtaining the interpersonal relationship chain data of the current user and before searching for the person matching the search keyword, further comprising:
performing expansion processing for interpersonal relationship chain data of the current user;
obtaining interpersonal relationship chain data of different intimate levels;
taking the interpersonal relationship chain data of different intimate levels as interpersonal relationship chain data to be searched.

7. The method of claim 1, wherein searching the person information corresponding to the interpersonal relationship chain data of the current user for the person matching the search keyword comprises:
searching out all persons matching the search keyword from a person database;
selecting a person belonging to the interpersonal relationship chain data from the person searched out from the person database.

8. The method of claim 1, further comprising:
configuring an interpersonal relationship chain database for users in advance; and
configuring person index information of interpersonal relationship chain data of each user in the interpersonal relationship chain database;
wherein searching person information corresponding to the interpersonal relationship chain data of the current user for a person matching the search keyword comprises:
searching out person index information of the interpersonal relationship chain data of the current user according to an identifier of the current user;
searching the person index information of the current user for the person matching the search keyword.

9. The method of claim 1, when more than two persons matching the search keyword are searched out, further comprising:
performing weighted calculation for the more than two persons matching the search keyword;
sorting the more than two persons matching the search keyword according to a weighted result;
wherein taking the person matching the search keyword as a search result comprises:
taking the sorted more than two persons matching the search keyword as the search result.

10. The method of claim 9, a weighted factor of the weighted calculation comprises at least one of:
an intimate level of a person in an interpersonal relationship of the current user;
the number of mutual buddies of a person and the current user; and
whether a person has a weak community relationship with the current user.

11. The method of claim 1, wherein the interpersonal relationship chain data comprises interpersonal relationship chain data of different intimate levels; or comprises interpersonal relationship chain data of different intimate levels and weak community relationship data.

12. A person search apparatus, comprising: a memory and a processor for executing instructions stored in the memory, the instructions comprise:
a search request instruction, adapted to receive a search request, the search request comprising a search keyword and information of a current user;
a data obtaining instruction, adapted to obtain interpersonal relationship chain data of the current user according to the information of the current user;
a matching instruction, adapted to search person information corresponding to the interpersonal relationship chain data of the current user for a person matching the search keyword; and
a result instruction, to take the person matching the search keyword as a search result.

13. The apparatus of claim 12, further comprising:
an interpersonal relationship chain database, adapted to store the interpersonal relationship chain data;
wherein the data obtaining instruction is to obtain the interpersonal relationship chain data of the current user from the interpersonal relationship chain database via a search interface.

14. The apparatus of claim 13, further comprising an index instruction and an index data storage; wherein
the index instruction is to configure person index information of interpersonal relationship chain data of each user in the interpersonal relationship chain database and store the person index information in the index data storage; and
the matching module comprises:
a first searching instruction, to search the index data storage for person index information of the interpersonal relationship chain data of the current user according to an identifier of the current user; and
a second searching instruction, to search the person index information searched out by the first searching unit for the person matching the search keyword.

15. A storage medium, storing computer programs, which, when executed by a processor, will cause the processor to:
receive a search request, the search request comprising a search keyword and information of a current user;
obtain interpersonal relationship chain data of the current user according to the information of the current user;
search person information corresponding to the interpersonal relationship chain data of the current user for a person matching the search keyword; and
take the person matching the search keyword as a search result.
